(19) United States
(12) Patent Application Publication
(10) Pub. No.: US 2005/0263228 A1
(43) Pub. Date: Dec. 1, 2005

(54) Disposable tire/wheel cover

(76) Inventors: William D. Martin, Las Vegas, NV (US); Elizabeth J. Martin, Las Vegas, NV (US)

Correspondence Address: Elizabeth J. Martin, 1606 Chapman Drive, Las Vegas, NV, 89104, US

(21) Appl. No.: 10/854,860

(22) Filed: May 27, 2004

(51) Int. Cl. B60C 7/22

(52) U.S. Cl. 152/170

(57) ABSTRACT

A disposable, tire/wheel cover for protecting flooring against inclement weather conditions, scuffing, and sharp or abrasive objects. The use of disposable tire/wheel covers is not limited to the aforementioned environments. Each environment requires a tire/wheel cover made of material having specific characteristics. The tire/wheel cover material may be from a wide array of materials including polyethylene, polypropylene, non-woven, and/or translucent materials. The elasticity of the material allows the tire/wheel cover to hug the tire/wheel to minimize slipping between the tire/wheel and the tire/wheel cover. The tire/wheel cover is a diameter shape and sized for a variety diameter size tires/wheels on hand trucks, dollies, etc. and is slipped over and around the tire/wheel and held with elastic.

### FIELD OF INVENTION

In the construction, moving and heavy-industry there is a need to protect the flooring from harsh elements. Such protection should be convenient to transport and to use, relatively light weight and disposable. Movers, appliance installers, various construction workers use hand trucks or dollies to mobile in furniture, appliances and other items into a house, office and commercial buildings. They lay down rolls of plastic or cut up cardboard and use as runners in order to prevent damaging tire/wheel marks, also preventing harsh weather conditions such as, in the rain, snow, sleet, mud, etc. tires/wheels on hand trucks or dollies cause. When rolling in cumbersome in size, bulky to transport items over marble, tile, carpet, vinyl flooring, wood flooring and decorative flooring the tire/wheel cover would eliminate any potential damage to flooring, be less trouble sum and less expensive than laying rolled plastic or cutting cardboard in the lengthily distance the item on the hand truck or dolly must be rolled to the dropping point. With the tire/wheel cover it will free up the time consuming of repositioning of the rolled plastic or cut up cardboard as the hand truck or dolly continues to the destination point within the facility. With the tire/wheel cover the hand truck or dolly is free to move about in any direction and distance. Due to weather conditions a hand truck or dolly is rolled outside of the house, office or buildings and the tires/wheels are picking up the elements such as water, snow, sleet, mud etc. therefore, when entering the house or building the elements no mater how much rolled plastic or cardboard is laid on the flooring the outside elements will not be disposed and will cause damage. With the disposable tire/wheel cover the person using the hand truck or dolly can easily place the disposable tire/wheel cover over the tire/wheel of the hand truck or dolly therefore, eliminating the damage to inside flooring. When exiting the house or building the tire/wheel cover is either disposed of or washed for reusing until worn out.

Thus, there is a need for a disposable adequately durable tire/wheel cover that is convenient to apply and is readily available for use.

### BRIEF SUMMARY OF THE INVENTION

Briefly, according to an aspect of the invention, a disposable tire/wheel cover is a dimensional cover closing around the tire/wheel in whole covering close to the axel.

According to another aspect, a disposable tire/wheel cover is sized for a various of different tire/wheels diameters.

According to another aspect, a tire/wheel cover material may be disposable, washable and reusable from a wide array of materials including polyethylene, polypropylene, non-woven materials and maybe translucent.

According to another aspect, the disposable tire/wheel cover will protect the flooring from harsh elements like water, snow, sleet, mud, tire marks, scuffing, etc.

To the accomplishment of the foregoing and related ends, the invention, then, comprises the features hereinafter fully described and particularly pointed out in the claims. The following description and the annexed drawings, although not necessarily to scale, set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE SEVERAL VIEW OF THE DRAWING

In the annexed drawings:

FIG. 1 is a perspective view of a disposable tire/wheel cover in accordance with the invention.

FIG. 2 is a top plan view of the fabric cut for the tire/wheel cover before the elastic is pulled through and permanently attached.

FIG. 3 is a top plan view of the disposable tire/wheel cover after the elastic is attached.

FIG. 4 is a side elevation view of the disposable tire/wheel cover being applied over a tire/wheel.

FIG. 5 is a backside elevation view of the disposable tire/wheel cover when completely covering the tire/wheel.

### DETAILED DESCRIPTION OF THE INVENTION

In the detailed following the description identical components have been given the same reference alpha letters in the several figures.

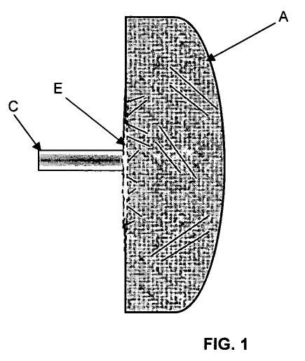

Referring to FIG. 1, A disposable tire/wheel protector or tire/wheel cover according to the invention is shown. The illustrated tire/wheel cover FIG. 1.A is made from an material which deforms over the surfaces of the tire/wheel on which it is placed. The tire/cover is of different diameter sizes for different tire/wheel diameters on which it is to placed, able to fit fully to the whole tire/wheel close to FIG. 1.C the axel. The tire/wheel cover may fit relatively securely to the tire/wheel with FIG. 1.E elastic therefore, the tire/wheel cover will not tend to move or will only move relatively minimally against the tire/wheel.

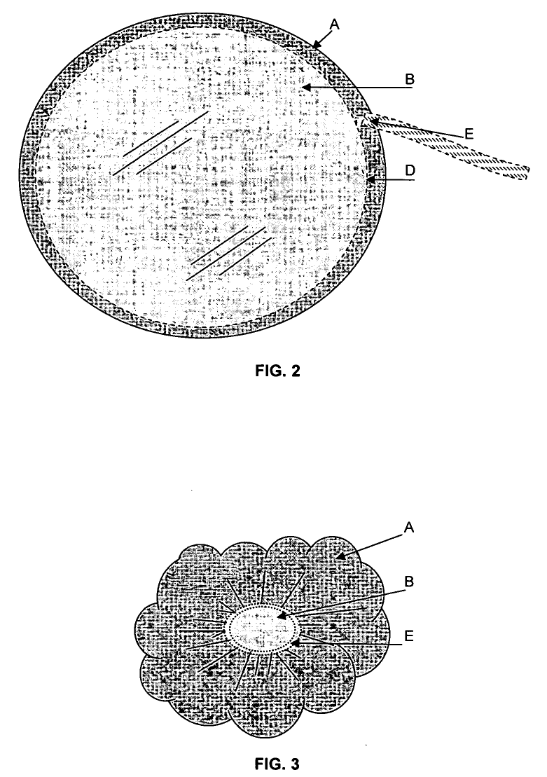

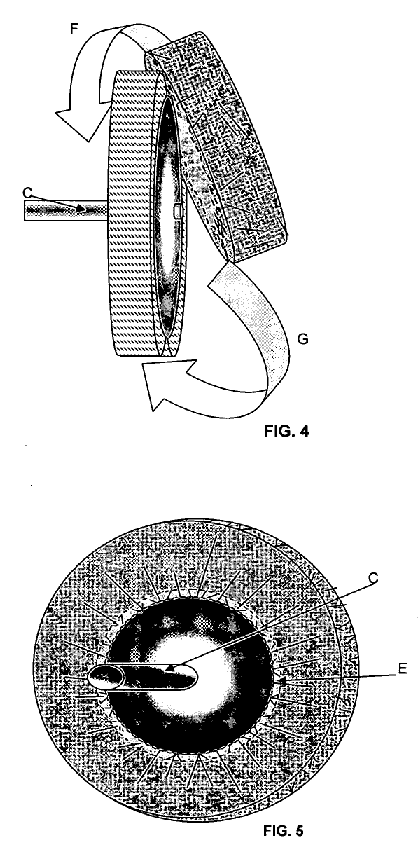

FIG. 2 Illustration is the fabric made of array of materials including polyethylene or polypropylene sheet materials, non-woven, and/or translucent materials cut into different diameters. FIG. 2.A The front side of fabric and FIG. 2.B inside of fabric folded and stitched as shown FIG. 2.D then the elastic is drawn through FIG. 2.E and pulled tight and stitched closed for a stretchable opening as illustrated FIG. 3. The FIG. 3.A outside fabric is turn over FIG. 3.B inside as the FIG. 3.E elastic is inserted and stitched closed that when pulled over the tire/wheel as illustrated on FIG. 4. The tire/wheel cover is stretched over the tire/wheel FIG. 4.F from the top of the tire/wheel and pulled down and around the bottom FIG. 4.G until the entire tire/wheel is covered in whole close to the axel FIG. 4.C. FIG. 5 Illustrates the tire/wheel cover completely covering the tire/wheel tightly close to the FIG. 5.C axel. FIG. 5.E Illustrated the elastic pulling the fabric close to the axel FIG. 5.C and holding it on the tire/wheel.

Industrial Application. It will be appreciated that the tire/wheel covers of the invention may protect interior flooring of many kinds.

1. A disposable tire/wheel cover, comprising:
a diameter shape tire/wheel cover to fit in close fitting relation with a tire/wheel of different diameters, wherein the tire/wheel cover includes a material that is flexible, elastic, substantially waterproof said material from a wide array of materials including polyethylene or polypropylene sheet materials, non-woven, and/or is translucent.

2. A tire/wheel cover according to claim 1, wherein the tire/wheel cover is made of different diameters for different diameter tires/wheels.

3. A tire/wheel cover according to claim 1, wherein the tire/wheel cover is tightly held onto the tire/wheel with elastic.
